(19) United States
(12) Patent Application Publication
(10) Pub. No.: US 2003/0171939 A1
(43) Pub. Date: Sep. 11, 2003

(54) Method and apparatus for prescreening passengers

(75) Inventors: John Paul Yagesh, Gaithersburg, MD (US); Christopher John Yagesh, Alexandria, VA (US); Christopher Joseph Bender, Arlington, VA (US)

Correspondence Address: WALL MARJAMA & BILINSKI, 101 SOUTH SALINA STREET, SUITE 400, SYRACUSE, NY, 13202, US

(73) Assignee: Millennium Information Systems LLC

(21) Appl. No.: 10/055,684

(22) Filed: Jan. 23, 2002

(51) Int. Cl. G06F 17/60

(52) U.S. Cl. 705/1

(57) ABSTRACT

A system and method for monitoring and regulating the transportation of hazardous material. The system and method provides an integrated knowledge management system specifically configured for the tracking, monitoring and management of hazardous materials while in transit and permits real-time tracking using GPS (Global Positioning System) and GIS (Geographic Information System) technology that provides automatic alarms on the occurrence of conditions of concern such as deviation from planned route, proximity to sensitive sites (government facilities, power generating plants, bridges, military bases, airports, skyscrapers, shopping malls, sports arenas, etc.), unanticipated delays, driver alarm, discrepancies between registered and observed condition at weigh stations, convergence of multiple hazardous material shipments, and other potentially dangerous incidents or conditions. The system also includes a method and apparatus for the pre-screening of passengers scheduled to travel on a carrier to determine whether they pose a threat to the carrier.

### FIELD OF THE INVENTION

This invention relates to the field of transportation of people and hazardous materials, and particularly to the field of the monitoring of such transportation.

### BACKGROUND OF THE INVENTION

The present invention is directed to a system and method for monitoring and regulating the transportation of people and hazardous materials. Each day, millions of kilotons of cargo move into and across the nation, including approximately 10.8 million tons of hazardous materials (HazMats) that, alone or when combined with other materials, could be used in an act of terrorism. To provide protection against such an act, it is desirable that authorities be able to identify such hazardous cargo, as well as operators or passengers that may harmfully use such cargo, as they pass through land, air, and sea modes of the existing intermodal transportation system. In order to efficiently guard against potential terrorist attacks, authorities need to be able to detect any unusual or potentially dangerous activity and to notify the appropriate authorities if such activity were to occur.

Currently, the Department of Transportation (DOT) has jurisdiction for most of the laws and regulations that relate to the transportation of cargo including the transportation of hazardous materials in the United States. DOT does not, however, have any national mechanism to track the real-time movement of cargo, nor does it have any established mechanisms for coordinating information concerning the transportation of HazMat cargo with law enforcement authorities.

Further exacerbating this problem is the lack of a single source of data or regulations regarding HazMat loads, trucks drivers, and routes. Data and regulations are dispersed between the shippers, the carriers, the Departments of Labor, Commerce, Transportation, and the EPA, among others. Additionally, each state has specific requirements for drivers, loads, and HazMat routes. There is a need to gather this disparately sourced information into a single repository to establish a baseline for tracking these hazardous materials loads, not only on the nation's highways, but on other carrier assets as well. Currently, a HazMat load can enter the United States via ship, then be trucked to a railhead for transcontinental transportation and then be flown intrastate to its final destination.

The hazardous materials transported on these carrier assets pose a hazard in and of themselves. Intentional misappropriation/misuse of these materials can pose a serious explosive, chemical, or biological threat to both property and the public. The location of these potential mobile agents of mass destruction needs to be monitored to prevent their utilization as weapons of attack by terrorist. An additional constraint when considering tractor/trailer HazMat loads as a threat is that it would be virtually impossible to shut down the movement of these trucks as was done with the commercial air system. There is neither the communications infrastructure to issue the directive nor the law enforcement resource to police the directive.

In addition to the commonly known hazardous materials, recent events have shown that other materials, such as airplane engine fuel may be very hazardous if wrongly used and redirected by a terrorist or the like. Thus, in addition to the materials themselves, the carrier operators and passengers must be considered as possible threats in relation to the use/misuse of hazardous materials.

While baggage checks have become common in the airline industry, there has been little or no screening of individuals prior to the boarding process. This is primarily because of the great volume of passengers and the attendant time that would be required to screen them all.

### DESCRIPTION OF THE RELATED TECHNOLOGY

Numerous different systems have been used to track vehicles and cargo. About 95% of rail cars have radio frequency transponders that transmit location and cargo information. The trucking industry uses GPS technology to make sure their trucks will make their schedules and to optimize route selection. The air traffic control system tracks aircraft by a combination of radar and transponders that combine information from flight plans to provide dynamic tracking and data tags for planes. All of this data is collected for different purposes, and is not maintained in a central repository or linked in a way that law enforcement can make use of such information to detect and respond proactively to any potential dangers.

Vehicle tracking technology in the trucking industry has been available for some time now. Onboard Computers (OBCs) from companies such as XATA have been paired with fleet mobile communication providers such as HighwayMaster (now @Track Communications) to offer a voice and data communications capability combined with satellite-based GPS vehicle location technologies. One of the advantages of this particular pairing is that the OBC has a predetermined route programmed into it as an aid to the driver. These routes can be best time, least mileage, or only available (tunnel restrictions, overpass height limitations, etc.) and can be utilized as a base to track spatial or time deviations. Similar services are also available from competitors such as ORBCOMM, which is also involved with ocean vessel tracking and aviation weather service direct to the cockpit via their own low-earth orbit satellite system. QUALCOMM has also teamed with ORBCOMM to offer a satellite-based trailer tracking system developed by Vantage Tracking Solutions, a business unit of ORBCOMM.

The majority of existing, mature tracking systems view the driver/tractor/trailer as a single entity. The current systems are not particularly concerned about the driver (from a tracking perspective) and the primary focus is on the tractor, presuming that the trailer, or load, will remain with the tractor. There are some system routers associated with tracking that provide a provision for a “drop and switch” within a pre-planned route. These systems basically form a new entity relationship between driver/tractor/trailer and continue to track the load utilizing the same presumptions. The majority of existing vehicle tracking systems are utilized primarily to provide ETAs at destinations to facilitate some time critical event such as unloading or to meet a just-in-time manufacturing requirement.

GeoCom offers a stand alone, self-contained trailer tracking feature marketed as GeoNav Trailer Tracking. Another trailer tracking capability is offered by Vantage Tracking Solutions, a division of ORBCOMM. This technology has been evaluated and selected by Schneider National, one of the largest truckload carriers in the United States.

MileMaker, Rand McNally's Routing & Mileage Software System, is one of many technologies that provides efficient routing for commercial trucking. In addition, many large trucking companies have their own proprietary systems that permit routes to be translated into latitude and longitude points and laid down as a layer on a GIS Geographic Information System, which also calculates arrival and departure times, and allows for a visual map presentation of an object's spatial position.

A variety of systems for tracking vehicles are disclosed in the following United States patents:

| U.S. Pat. No. | Inventor | Issue Date | Title |
|---|---|---|---|
| 4,973,970 | Reeser | Nov. 27, 1990 | Integrated automated |
| | | | system for waste site |
| | | | characterization |
| 5,347,274 | Hassett | Sep. 13, 1994 | Hazardous waste transport |
| | | | management system |
| 5,504,482 | Schreder | Apr. 2, 1996 | Automobile navigation |
| | | | guidance control and safety |
| | | | system |
| 5,774,876 | Wooley | Jun. 30, 1998 | Managing assets with active |
| | | | electronic tags |
| 5,825,283 | Camhi | Oct. 20, 1998 | System for the security and |
| | | | auditing of persons and |
| | | | property |
| 5,880,958 | Helms | Mar. 9, 1999 | Method and apparatus for |
| | | | freight transportation using |
| | | | a satellite navigation system |
| 5,917,433 | Keillor | Jun. 28, 1999 | Asset monitoring system |
| | | | and associated method |
| 5,983,161 | Lemelson | Nov. 9, 2001 | GPS vehicle collision |
| | | | avoidance warning |
| 6,084,510 | Lemelson | Jul. 4, 2000 | Danger warning and |
| | | | emergency response system |
| | | | and method |
| 6,141,609 | Herdeg | Oct. 31, 2000 | Device for recording |
| | | | information on a vehicle's |
| | | | itinerary |
| 6,195,609 | Pilley | Feb. 27, 2001 | Method and system for the |
| | | | control and management of |
| | | | an airport |
| 6,232,874 | Murphey | May 15, 2000 | Vehicle user control |
| 6,249,241 | Jordan | Jun. 19, 2001 | Marine vessel traffic system |
| 6,275,773 | Lemelson | Aug. 14, 2001 | GPS vehicle collision |
| | | | avoidance warning and |
| | | | contol system and method |
| 6,282,362 | Murphy | Aug. 28, 2001 | Geographical position/ |
| | | | image digital recording and |
| | | | display system |
| 6,314,363 | Pilley | Nov. 6, 2001 | Computer human method |
| | | | and system for the control |
| | | | and management of an |
| | | | airport |

The entire disclosure of each of the above-referenced United States patents is hereby incorporated by reference herein.

### SUMMARY OF THE INVENTION

A system and method for monitoring and regulating the transportation of hazardous materials may take the form of a remotely hosted system monitored by a central service provider or as a software system compatible with modern PC platforms linked over the Internet or any closed/private data network. The system and method provides an integrated knowledge management system specifically configured for the tracking, monitoring and management of hazardous materials while in transit and permits real-time tracking using GPS (Global Positioning System) and GIS (Geographic Information System) technology that provides automatic alarms on the occurrence of conditions of concern such as deviation from planned route, proximity to sensitive sites (government facilities, power generating plants, bridges, military bases, airports, skyscrapers, shopping malls, sports arenas, etc.), unanticipated delays, driver alarm, discrepancies between registered and observed condition at weigh stations, convergence of multiple hazardous material shipments a passenger that poses a threat, and other potentially dangerous incidents or conditions.

The system and method provides the capability for responsible parties to monitor the location, status, and progress of hazardous material shipments, or other shipments of particular concern, as they travel. The system and method may be applied to all commercial transportation modalities including truck, aircraft, vessel/barge, rail, and bus, and can serve to monitor hazardous material as it transfers among multiple modalities.

The system and method permits civil authorities such as staff at weighing stations, toll plazas, sea ports, airports, and rail yards, or police officers to interrogate a remote database via an Internet website using wireless terminals such as PDAs or mobile data terminals in order to confirm that observed conditions regarding the vehicle of carriage, its driver pilot or passenger, and the hazardous material shipment itself match the registered information for the shipment, and interfaces with existing governmental and civilian law enforcement communications networks to provide advance warning of potentially dangerous conditions or events.

The system also provides for the pre-screening of carrier passengers to identify and take appropriate action against any that pose an apparent threat to normal operation. Data relating to the passenger, the carrier and its schedule is acquired from airline or other flight reservations and used to enter other databases, and the results is compared with forensic data bases of national law enforcement and civil security agencies to determine whether the passenger should be allowed to continue his travel.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWING

FIG. 1 is a flow chart illustrating the process of a preferred embodiment of the present invention;

FIG. 2 is a schematic of the intermodal relationship between the components of a preferred embodiment of the present invention;

FIG. 3 is a schematic of the threat identification notification of a preferred embodiment of the present invention; and

FIG. 4 is a screenshot of a graphic user interface of a preferred embodiment of the present invention.

FIG. 5 is a schematic illustration of a filter and funneling concept applicable to the present invention.

FIG. 6 is a diagrammatical illustration of a passenger threat identification detection and notification system of the present invention.

FIG. 7 is a schematic illustration of the process of passenger data collection in accordance with a preferred embodiment of the invention.

FIG. 8 is a schematic illustration of a decision/support function of the present invention.

### DETAILED DESCRIPTION OF PREFERRED EMBODIMENT(s)

The present invention provides systems and processes for the monitoring and/or regulation of transportation, and particularly for the transportation of critical cargo such as materials categorized as hazardous materials (referred to as “HazMat”). The system and processes of the present invention can be implemented in different modes of transportation. Examples of the different transportation modes includes but are not limited to truck, aircraft, rail, barge, ship, bus and any other transportation system presently in existence or as developed in the future.

A preferred embodiment of a system embodying some of the elements of the present invention is provided herein for explanatory purposes. It is to be expressly understood that this descriptive embodiment is intended for explanatory purposes only and is not meant to limit the scope of the claimed inventions. Other embodiments that may include less or more of these elements as well as elements that are known to those skilled in the art or as hereafter developed are also considered to be within the scope of the claimed inventions.

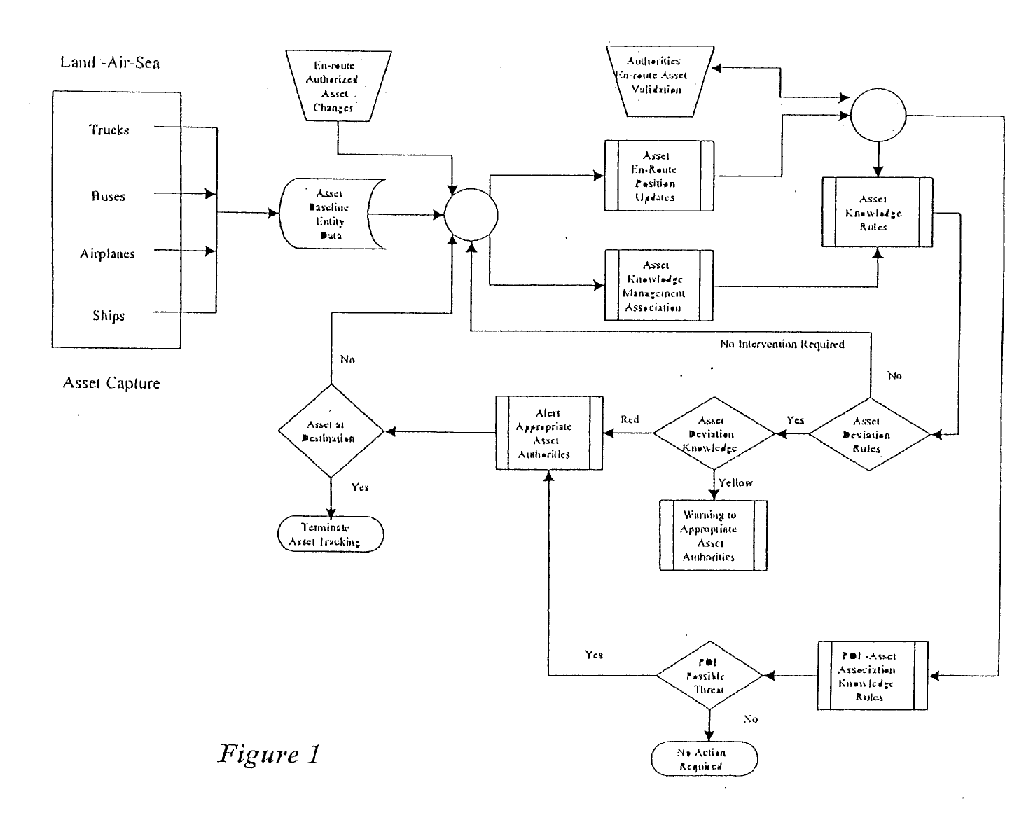

In the preferred embodiment described herein, the system can generally be categorized under three general modules: Identification and Tracking of Assets; Detection of Threatening Conditions; and Threat Notification of Appropriate Authorities and Entities. Each of these general modules includes specific system modules for implementing the system of the present inventions. Referring now to the drawings, wherein like reference numerals designate corresponding structure throughout the views, and referring in particular to FIG. 1, a preferred embodiment of the present invention is illustrated.

An overview of the process of a preferred embodiment of the present invention is illustrated in FIG. 1. Each of the components of this process will become evident in the ensuing description of a preferred embodiment of the present invention.

All commercial shipments of HazMat cargo whether truck, aircraft, rail, barge or ship, bus, or any other method that transports cargo have certain common characteristics:

1. All HazMat cargos (presenting a risk above some de minimus level) are formally registered into the transportation system as a legal requirement set forth at 49CFR172 Subpart C. To put it differently: when the HazMat crosses the system boundary into the system, information about the HazMat shipment is introduced into the transportation information system.

2. All vehicles carrying HazMat are tagged with some identifier whether N—number, railcar number, license plate number, etc. All of these vehicles are tagged and registered into some federal and or state-owned or potentially state-accessible information system.

3. Some human operator operates all vehicles carrying HazMat whether pilot, engineer, or driver with all that such human involvement implies.

4. All of these vehicles have or could be mandated to have registered routes of travel that either are or should be entered into information systems prior to the carriage of HazMat.

5. All vehicular traffic is potentially monitorable whether through the use of communicated GPS positional data or via some other technology such as On-Star, Lo-Jack, QualComm, or others.

These commonly shared characteristics of all transportation modalities may be subject to transportation oversight management by the system of a preferred embodiment of the present invention. This preferred embodiment is a knowledge management system optimized for the management of the transportation of HazMat materials, and the system requires only moderate adaptation to move from one transportation modality to another.

Knowledge Management Systems (KMS) are characterized by an ongoing, persistent interaction with existing organizational information and data applications that produce and maintain knowledge, and inform system operators about developments within the System Knowledge Base (SKB). An SKB is comprised of sets of remembered information and data including validated rules, metrics, propositions, and models that are used to identify changes to the over-all state of a business area.

An SKB continuously enhances its knowledge base through sensing, monitoring, and learning—often referred to as Knowledge Acquisition. This Knowledge Acquisition is used to derive essential knowledge relevant to adverse events and situations that are negatively affecting or could potentially degrade the desired state of being (in this case intermodal transportation threats to homeland security across a nation).

The present system can easily be made to monitor the transmission of HazMat cargos through multimodal transit, as when a package of bio-hazardous material is put on an airplane from LAX to IAD and then put on a truck for overland carriage to Fort Detrick, Maryland. The utility of this adaptive power is obvious.

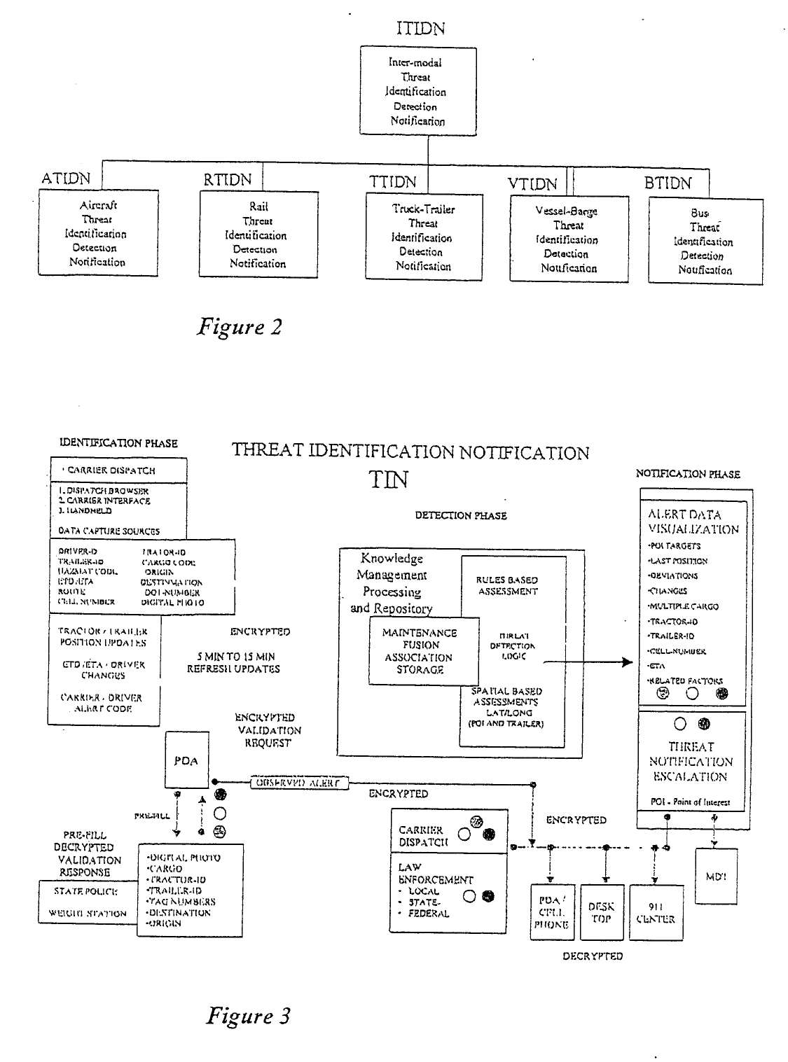

FIG. 2 illustrates the structure of a preferred embodiment of the system of the present invention and shows the relationship of the modalities of this structure. Each of the important cargo transportation modalities, such as aircraft, rail, trucks, ships, and buses presents its own unique characteristics, but each of these characteristics can be accommodated. These characteristics include time, distance, location, and Point of Interest (POI) proximity based on spatial location associations. These characteristics are described in greater detail below by transportation modality. Initially, however, the description is limited to the identification phase of the system operations because this initial data capture phase of the system operation is the phase that is inflected by the various transportation modalities. The detection phase and the notification phase are essentially identical for all of the modalities addressed.

Although the category of tractor/trailers and other large trucks has, as a transportation medium, its own distinctive characteristics, it shares many of the characteristics of all of the HazMat cargo transport modalities embraced by the system of a preferred embodiment of the present invention. Therefore the use of the present system on tractor/trailers will serve as an exemplar of how, in a particular case, the system of a preferred embodiment of the present invention system may be implemented. It also serves to illustrate the need for and the logic of a fully integrated HazMat transport management system such as the system of a preferred embodiment of the present invention. Much of the HazMat will be transported multi-modally.

The commonalities among the various modalities make possible the use of the same fundamental architecture in support of the identification, detection and notification phases of the operational system.

A) Truck-Trailer Threat Identification—Detection—Notification (TTIDN)

The system operations for the Truck-Trailer Thread Identification Detection and Notification system (“TTIDN”) is described below. There presently exists many resources dedicated to the oversight and monitoring of this particular mode of transportation. This mode of transportation is particularly relevant based on terrorist threats that are feasible and plausible using easily commandeered tanker trucks, traveling at 100 mph to spread fear and terror in residential or densely populated downtown areas of any city or neighborhood. The ease by which these rolling assets can be acquired and misused is considerably easier to envision because multiple hijackings are so much easier to perpetuate, with no real security to compromise. In describing TTIDN applicability, an example of HazMat cargo that includes Class 3 Flammable Liquids is used. It is to be specifically understood that other types of cargo may be covered within the scope of the present invention.

B) The TTIDN Identification Phase and Tracking of Assets.

A modern tractor/trailer might carry a gross weight of 80,000 pounds at velocities up to 100 MPH. This represents an enormous capacity for destruction in the wrong hands. Moreover, shipment of HazMat by truck constitutes an enormous component of all HazMat shipments. A 1998 report (“Hazardous Materials Shipments”) prepared by the United States DOT Office of Hazardous Materials Safety indicates that trucks make fully 94% of all HazMat shipments. It is interesting to note that, by contrast, trucks carry only 43% of HazMat tonnage. This 2:1 discrepancy is caused chiefly by the fact that pipelines carry a very large proportion of the tonnage of HazMat, virtually all of which constitutes petroleum products. It should be noted, too, that pipelines, because of their immobility and the fact that they are seldom routed through urban areas, are substantially less of a threat to most sensitive targets than their proportion of HazMat carriage would suggest.

The first thing which must be done in creating an effective TTIDN is preferably to assemble a useful body of information about all HazMat over-the-road shipments. This data will be rather voluminous: the United States Department of Transportation reports that there are more than 800,000 shipments of hazardous materials daily in the US; about 80% of which are fuel trucks. This astonishingly large number includes a great many local home fuel delivery shipments. While the system of a preferred embodiment of the present invention system is scalable to include such traffic, it has particular applicability to the most threatening cases, viz., large, over-the-road HazMat shipments.

This data about the shipment, the vehicle which is carrying it, and the driver who is piloting it, come in a variety of formats. Some of such data must be inputted to the system by cooperating humans, some by devices. All of this data must come from local sources: dispatchers at commercial carriers, local truck weighing stations, local law enforcement agencies, and from the moving truck itself.

FIG. 3 shows the identification phase/data capture operations of the system of a preferred embodiment of the present invention system. Operators who have write-only access to the system of a preferred embodiment of the present invention system must provide some of the necessary data for effective system operation as inputs to the system. In the most common case, the operator must be a party connected with the over-the-road carrier itself, because this is the point at which data capture can be made obligatory and the point at which fundamental practical decisions about the HazMat shipment are made.

1) Data Fields to be Completed by the Carrier.

In the TTIDN system the following items of data are to be inputted by the dispatcher (or a person with a somewhat similar role) at the office of the carrier:

Driver ID including Driver's name, SSN, INS registration (if any), CDL Number.

A digital photograph similar to and governed by the rules for a US Passport photograph.

Tractor ID Number/DOT Number.

Trailer ID Number/DOT Number.

Communications Device Identification Number (Cellular phone, etc.).

HazMat/Cargo Code per US DOT Regulations.

Estimated Date and Time of Departure.

Estimated Date and Time of Arrival.

Point of Origin/Departure in either Latitude/Longitude or Street Address format.

Point of Destination in either Latitude/Longitude or Street Address format.

Route Description: Turn-by-Turn (e.g., MapQuest format).

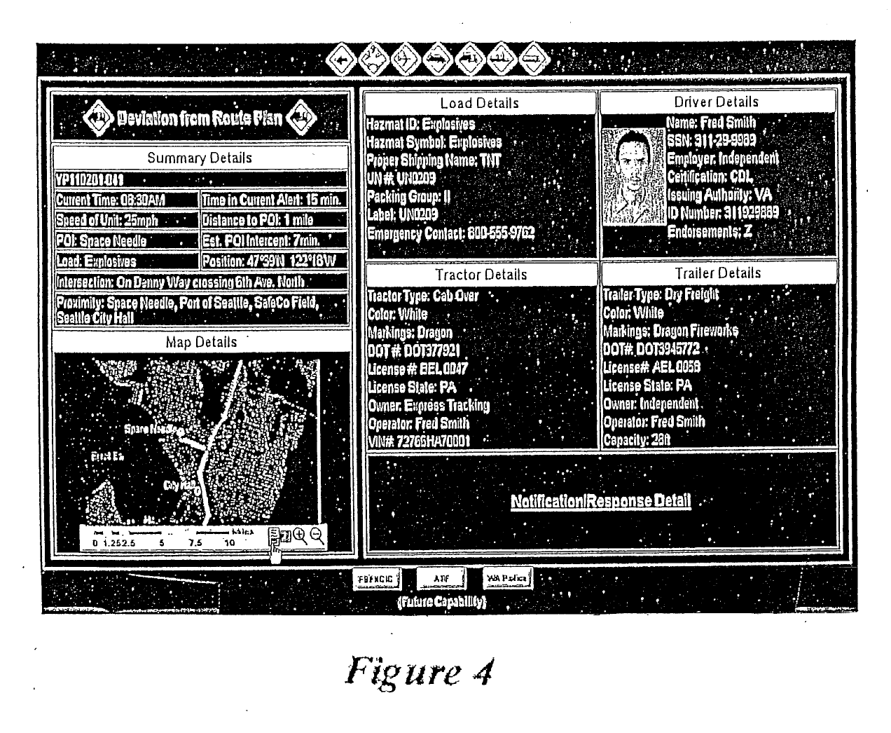

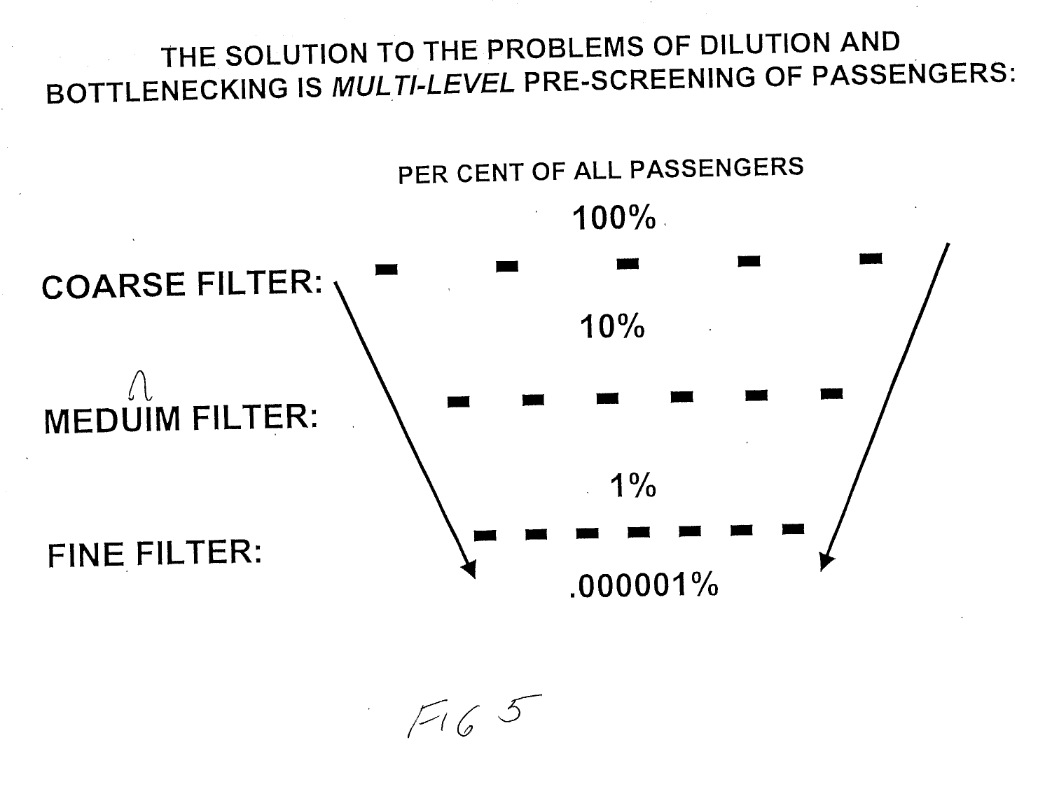

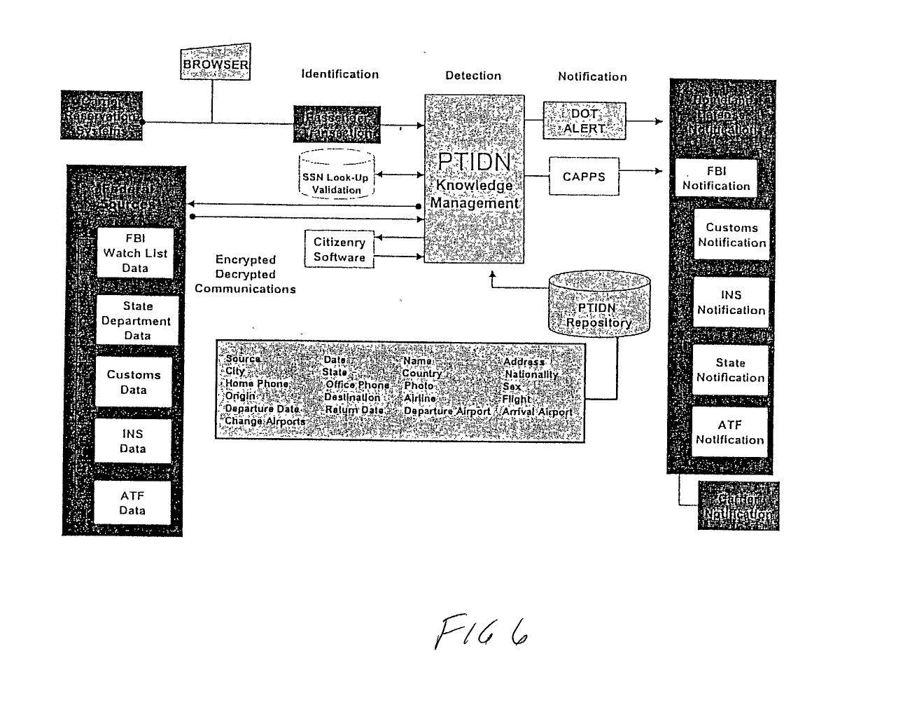

The TTIDN system provides for such data input by the carrier dispatcher over the Internet and provides a hosted data center with a simple, user-friendly GUI and screen sequence such that a person of ordinary computer competence can input this data. An example of such a GUI is shown in FIG. 4. Comprehensive data visualization with ease of use and the use of automated data inputs to the system at every point are emphasized. The focus is on turning data into information and conveying knowledge about a situation from that information. A set of common data fields for the entry of all of the information noted above and a quality-assurance feature that ensures that all data is in correct format are provided. TTIDN also provides a defined XML wrapper for data that allows any existing information system used by a carrier to provide data via the Internet or a simple modem connection.

It is anticipated that all of these fields will be completed prior to the commencement of any HazMat transit. However, the TTIDN system also makes provision for security-protected modification of the initially inputted parameters. If, for instance, the original driver is taken ill while on the road and is replaced by a new driver or if the original tractor is replaced by another; the TTIDN will permit the dispatcher to re-enter the registration file using the TTIDN file ID number and make this modification without precipitating an alarm.

2) Data Entered at the Tractor/Trailer.

The tractor/trailer is a mobile asset, and the TTIDN system provides for the regular collection of data from the truck as it moves over the road carrying its HazMat load. This data is of three sorts:

Positional data: Positional data is developed and communicated automatically by an on-board GPS receiver/processor and a multi-mode communications transmitter or transceiver. The entire CONUS is within the footprint of GPS; absent some occlusion of a GPS timing signal from an adequate number of satellites (as when the truck is in a concrete structure like a parking garage) the GPS receiver will always have up-to-the-minute positional data which will be accurate within perhaps 10 meters virtually all of the time at the time of transmission. Thus, both the positional sensor data availability and communications link availability in the TTIDN system are of a very high order. The GPS receiver/processor, the communications transmitter/transceiver, an uninterruptible power supply and the encoder necessary for interface with the alarm sensors constitute the TTIDN mobile unit, and it is attached to the trailer in a tamper-proof fashion.

Alarm Data: The mobile unit is designed such that certain events will cause an alarm to be transmitted through the system. Conditions initiating an alarm will, in standard configuration, include the following:

(a) Driver compromise: The mobile unit will encode for driver alarm. If the driver is assaulted he can transmit a duress alarm to the mobile unit using either a wireless duress alarm transmitter or a carrier-current transmitter wired through the tractor's wiring harness to the trailer. Alternatively, an input of a rolling code (a numerical code that must be manually entered by the driver every designated time unit and which increments or decrements slightly every time in an easily-remembered fashion) such that the re-entry of a previously-observed code by a malefactor will result in an alarm.

(b) Tamper/compromise of the mobile unit: The mobile unit contains tamper sensors that will alarm at any attempt to remove or destroy the mobile unit or its communications antenna.

Vehicle Identification: Each mobile unit will have a programmable ID code such that a trailer identification number (typically the DOT number) is transmitted with each transmission of positional or alarm data.

3) Verification/Ground Truth Data Inputs.

There is another source of human-inputted data. The TTIDN system takes advantage of semi-regular stops of HazMat trucks (and other trucks) made by trusted parties, viz., local and state police and state DOT weighing stations. These stops represent opportunities for these affiliated parties to check reality against the data registered into the system by the carrier dispatcher. DOT and police officers are to be equipped with PDA's or other terminals via which they are able to enter data taken from the tractor, trailer, and driver for automated comparison with parallel data inputted at registration by the carrier dispatcher. Indeed, these data fields appearing on the respective GUI's for the carrier dispatcher and police/DOT weighing station will normally be exact counterparts to one another. At such data entry points, the identity of the party entering data will be made and confirmed using an encrypted secure mechanism for authentication and transmission.

Alternative Embodiments

The positional data developed by the GPS sensor and relayed by the wireless communication backbone is extraordinarily valuable because it permits real-time and highly precise tracking of the asset to be protected. It comes, however, at a cost. The positioning and communications equipment are, in communications terms, the remote ends of a multi-point-to-point communications network. They are, in other words, the portions of the system, which needs to be replicated for each asset to be surveilled. The system of a preferred embodiment of the present invention can manage a great many assets, but a mobile unit can monitor only one asset at a time.

It is, however, possible to achieve some of the TTIDN's functionality without the use of mobile units. In this case, the positional and temporal information, instead of being developed by the GPS sensor and relayed through the wireless infrastructure(s), is provided by the ground truth points (the weighing station officials and the police officers who make stops and enter such time and place data into their mobile terminals) and relayed through the Internet to the control monitoring station. In this fashion much of the functionality of TTIDN may be preserved with a substantial saving in system cost but at a substantial sacrifice in the timeliness and precision of the location data.

All data transmitted over the system of a preferred embodiment of the present invention communications backbone will be encrypted to a level as is mandated by the appropriate governing body.

C) The Detection Phase.

Detection phase functionality is accomplished at the Control/Monitoring Station (“CMS”); a C4I facility capable, in principle, of being sited anywhere in either a centralized or highly federated configuration. At the core of detection phase functionality is a proprietary knowledge management system. This core capability permits:

Archiving and storage;

Maintenance and reformatting; and

Manipulation (fusion, association)

of the data inputs to the system. These inputs, which have been made remotely via either the Internet (in the case of data inputted by the dispatcher or civil authorities) or over one or more wireless infrastructures (typically a trunked tactical mobile radio) in the case of data provided from the mobile unit.

An important key feature of the system of a preferred embodiment detection module is its rules-based threat detection logic. Remotely possible threat scenarios have been modeled and have established a set of knowledge-management and decision-making rules such that an emerging threat may be detected in virtually real time as it manifests itself or before it manifests itself at the asset to be protected. These rules are applied in several areas.

1) Spatially Based Assessments Relative to Deviations from a Pre-Established Route.

When a HazMat shipment is registered into the TTIDN system by the carrier dispatcher a unique file is created containing all of this data and given an identification number or code by the TTIDN system. This identifying code is also programmed into the mobile unit such that all data inputs to the TTIDN archive such that changes from the carrier, checks from the police or other authorities, or positional data updates from the truck are associated with this identifier. Thus, the archive file contains all of the identifying information supplied by the carrier plus a history of the route actually traveled by the trailer.

Accordingly, the TTIDN file contains two route data files: one describing the route plan and another created empirically as the truck proceeds and the mobile unit delivers positional data on a regular basis (e.g., updated every N seconds). TTIDN incorporates a sophisticated GIS functionality based on an ESRI COTS product to display the detection and evaluation of deviations between the route plan and the actual route. A rule might be established that the system will alarm when a deviation of more than one mile from the Route Plan is measured for a period of more than fifteen minutes. This grace period will permit ad hoc deviations for fuel, detours, etc. This rule can be changed automatically by contingency: the rule may be acceptable in rural areas but made more restrictive in urban areas or proximate to a sensitive area.

2) Spatially-Based Assessments: Proximity to Points of Special Interest.

The TTIDN makes it possible to distinguish between the critical assets and non-critical assets. For example, a truck traversing the famous stretch of Rt. 50 through southern Nevada, the Lonely Road, as it is called, will nowhere be proximate to a sensitive national target. The situation is very different at the eastern end of Rt. 50 where it passes through the District of Columbia. A truck on this stretch of Rt. 50 will be minutes from the White House, the Capital, and other sensitive national assets. Any effective threat assessment system will be able to detect the proximity of a HazMat load to such assets. TTIDN possesses such a capability.

Employing functionality of the GIS module TTIDN permits the visualization of a buffer zone around any sensitive asset. This will typically be a building but potentially could be anything with an identifiable location. The entry of the mobile unit aboard the trailer into this buffer zone will satisfy a rule requiring alarm upon such incursion. Such buffer zones may be denominated in units either of distance or of driving time. These rules may be changed on the fly; for instance, if a national terrorism alert goes out while a HazMat truck is on the road, it may be the buffer zones around certain critical national assets be increased for the duration of the alert.

3) Temporally Based Assessment.

Two of the dispatcher-supplied data fields are estimated time and date of arrival and departure. The TTIDN system will apply rules to any discrepancy between planned and actual (as indicated by the positional data file) ETD's and ETA's. Innocuous discrepancies caused by traffic delays, accidents and breakdowns are eliminated from the management process by reentry updated of ETA schedules by the dispatcher.

4) Dispatcher/Civil Authority Report Discrepancies.

Mobile data terminals provided to state and local police and state DOT truck checking stations along the registered route will allow for some ground verification of the system by affording civil authorities the opportunity to enter data into fields parallel to those provided for the dispatcher and to check for discrepancies. These fields include potentially any of those provided for the dispatcher, but would typically include Tractor ID, Trailer ID, Tag Number, several fields of manifest data, driver SSN and CDL, and a digitized photo of the driver.

5) Alarm Data.

Alarm data (driver duress, tamper) will require little processing and will be converted into an alarm after the application of initial false-alarm screening rules.

D) Notification Phase.

After TTIDN has determined the existence of a threat, the system initiates those operations associated with informing appropriate authorities of the threat. This phase of operations has two moments:

Alert Data Visualization.

TTIDN has a great deal of data in its HazMat transit file for the shipment that has just gone into alarm. Not all of this data needs to be delivered in raw form to all recipients of threat information, and that information which is delivered must be delivered in as clear and useful a form as possible, because response operations have now shifted into tactical mode, and time is of the essence.

Typically, all processed information will be provided to all interested parties equally and in the same form, but this need not be so. It may be that civil authorities will want certain data sets shielded from the freight carrier or will want the report delayed because of concerns about complicity by the carrier in a potentially illegal incident. TTIDN provides the flexibility to accommodate all such tactical considerations.

In the typical instance, TTIDN would provide a report, as shown in FIG. 4, containing several graphic and textual fields:

A GIS-generated map backdrop for the incident showing the point of the incident and any proximate sensitive targets;

A textual/numeric latitude/longitude description of the incident location;

A code for the nature of the incident and a legend for interpretation of the code (e. g., deviation from route, driver duress alarm, etc.); and

All of those data fields provided by the dispatcher, including a photo of the driver.

Threat Notification Escalation.

TTIDN will transmit these processed data sets to civil authorities on national and local levels based on a set of rules incorporated into the threat notification module, rules which will reflect both the nature and the location of the incident. An example of a communications structure is the existing National Law Enforcement Telecommunications Service, a national communications system dedicated exclusively to law enforcement, which has the capacity to rapidly, and securely conduct relevant information to all pre-selected parties. Although organized by the various state law enforcement agencies, the NLETS also enjoys the participation of both civilian and military federal agencies, and representatives of these federal agencies (FBI, Department of Treasury, etc.) sit on its Board of Directors. Although the bulk of the traffic through the NLETS system is devoted to automobile/vehicular information (stolen vehicle reports, license confirmations), the system is fully encrypted, and encryption is a desirable part of any communication system, which TTIDN uses. The NLETS system is organized as a network such that a message from any point in the system, local or federal can be transmitted to any other point or points in the system.

The information can provided to civil authorities in both fixed and mobile deployment (e. g., to PDAs and wireless via IP connectivity or to mobile data terminals in police cruisers via trunked digital tactical radio networks). The NLETS system utilizes a frame relay backbone and is currently carrying in excess of 795,000 messages per day among more than 150,000 terminals directly connected to the system.

The implementation of the system of a preferred embodiment of the present invention is described for over the road truck monitoring. In fact, of the several transportation modes that can be addressed by the system of a preferred embodiment of the present invention, trucks are the most difficult to monitor and represent the threat potential that is most critical to address. Railroad rolling stock, while it can carry heavier loads, is much more restricted in where it can travel and inherently more trackable than trucks.

Intermodal Threat Identification, Detection, and Notification Database Definitions and Model.

The data structure of the Intermodal Threat Identification, Detection, and Notification (the system of a preferred embodiment of the present invention) is divided into four logical sections. The logical foundation is the intermodal information section that contains information pertaining to the physical attributes and ownership of vehicle assets for five modes of transportation: truck, rail, aircraft, sea-going vessel, and bus. The data architecture allows for the integrated addition of other modes and/or subsets of the aforementioned modes of transportation.

The intermodal section is logically combined with cargo types, containers, and cargo classifications. The data architecture keeps and stores information relating to cargo independently of mode then provides relationships as any given piece of cargo is moved by a vehicle or makes a journey using multiple vehicles. This architecture provides for identification of cargo and vehicles in an integrated fashion, an independent verification, and changes over time.

When cargo is to be moved, any entity that is moving cargo provides a route plan that will include information on the cargo from the manifest, which vehicle(s) will be used, who the related operator(s) and owners(s) are, and when points in that route will be reached. The combination of vehicles, operators, and cargos comprise the identification phase of the system.

As an operator takes a vehicle and cargo on a route, data provided from electronic transponders, direct observation from law enforcement, weigh station operators, toll plaza workers, etc. is captured by the system and used to compare that information from the planned route plan. This comparison accounts for data pertaining to the vehicle or combination of vehicles, the physical operator (such as the driver of a truck), the cargo being moved, the physical route, and the planned versus actual timeframe.

In this detection phase, there are currently four defined operations that occur that will result in data provided to the notification phase. The data captured in the identification and detection phase is kept indefinitely and used for analysis purposes.

The four operations performed on the data are called:

Route Violations identifying deviation by time or space from a planned route plan.

Envelope Violations identifying the entering into a predefined area around a point of interest based on planned or actual route execution.

Cargo Violations identifying discrepancies in the planned versus actual of cargo type and amount being moved.

Transport Violations identifying discrepancies in the associated vehicle, equipment, or operator moving cargo.

These operations run continuously on the data captured by the system. When a violation is detected, data is passed to the notification phase that culls data related to the alert or combination of alerts and directs it to the appropriate recipients. Alert information is distributed via the application and is stored for analysis purposes.

The following table (Table 1) provides a list of tables and their primary key attributes. The next table (Table 2) provides a listing of each column attribute, by table.

TABLE 1
Tables and Primary key Attributes

| Table Name | Primary Key Attribute |
|---|---|
| Aircraft Detail | aircraft_id |
| Alerts | alert_id |
| Alerts | detection_id |
| AlertThread | thread_id |
| Assets | asset_id |
| BoxCarDetail | boxcar_id |
| BusDetail | bus_id |
| CabDetail | trailer_id |
| Cargo | cargo_id |
| Company | company_id |
| CompanyRoster | Roster_id |
| Detection | detection_id |
| Deviations | deviation_id |
| DeviationType | deviation_type_id |
| Driver | Driver |
| Enforcement | enforecment_id |
| Envelope | envelope_id |
| HAZMAT | hazmat_id |
| Metrics | asset_id |
| Metrics | envelope_-id |
| MobileAsset | mobile_asset_id |
| NoteThread | thread_id |
| Notification | notification_id |
| Notification | enforecment_id |
| Organization | org_id |
| RailDetail | rail_id |
| RailEngineDetail | engine_id |
| RoadPlan | road_plan_id |
| RoadPlan | mobile_asset_id |
| RoadThread | thread_id |
| Route | route_id |
| SecGroup | sec_id |
| Source | source_id |
| Symbol | symbol_id |
| TruckDetail | cab_id |
| TruckDetail | truck_id |
| Users | user_id |
| Validation | validation_id |
| VesselDetail | vessel_id |

TABLE 2
Column Attributes by Table

| Table Name | Column Attribute |
|---|---|
| AircraftDetail | aircraft_id |
| AircraftDetail | n_number |
| AircraftDetail | MMS |
| AircraftDetail | owner |
| AircraftDetail | Operator |
| AircraftDetail | color |
| AircraftDetail | capacity |
| AircraftDetail | markings |
| Alerts | alert_id |
| Alerts | detection_id |
| Alerts | alert_date |
| Alerts | status |
| Alerts | type |
| AlertThread | thread_id |
| AlertThread | detection_id |
| AlertThread | alert_id |
| AssetOperator | operator_id |
| AssetOperator | first_name |
| AssetOperator | last_name |
| AssetOperator | license_number |
| AssetOperator | license_state |
| AssetOperator | license_type |
| AssetOperator | address_1 |
| AssetOperator | address_2 |
| AssetOperator | state |
| AssetOperator | zip |
| AssetOperator | land_phone |
| AssetOperator | cell_phone |
| AssetOperator | email |
| AssetOperator | height |
| AssetOperator | weight |
| AssetOperator | hair_color |
| AssetOperator | eye_color |
| AssetOperator | distinguishing_marks |
| AssetOperator | citizenry |
| AssetOperator | photo |
| AssetOperator | photo_date |
| AssetOperator | SSN |
| AssetOperator | endorsements |
| AssetRoutePlan | plan_id |
| AssetRoutePlan | mobile_asset_id |
| AssetRoutePlan | origin |
| AssetRoutePlan | destination |
| AssetRoutePlan | submission_date |
| AssetRoutePlan | change_user_id |
| AssetRoutePlan | status |
| AssetRoutePlan | previous_road_plan_id |
| AssetRoutePlan | start_date |
| AssetRoutePlan | end_date |
| AssetRouteThread | thread_id |
| AssetRouteThread | mobile_asset_id |
| AssetRouteThread | road_plan_id |
| AssetSignage | signage_id |
| AssetSignage | poc_phone |
| AssetSignage | company_name |
| AssetSignage | address_1 |
| AssetSignage | address_2 |
| AssetSignage | state |
| AssetSignage | zip |
| AssetSignage | phone |
| AssetSignage | fax |
| AssetSignage | license_type |
| AssetSignage | license_number |
| AssetSignage | poc |
| AssetSignage | poc_cell_phone |
| AssetSignage | poc_email |
| BoxCarDetail | boxcar_id |
| BoxCarDetail | license_number |
| BoxCarDetail | type |
| BoxCarDetail | capacity |
| BoxCarDetail | owner |
| BoxCarDetail | operator |
| BoxCarDetail | color |
| BoxCarDetail | markings |
| BusDetail | bus_id |
| BusDetail | bus_type |
| BusDetail | color |
| BusDetail | markings |
| BusDetail | DOT_number |
| BusDetail | license_number |
| BusDetail | license_state |
| BusDetail | owner |
| BusDetail | operator |
| BusDetail | VIN |
| CabDetail | cab_id |
| CabDetail | cab_type |
| CabDetail | color |
| CabDetail | markings |
| CabDetail | DOT_number |
| CabDetail | license_number |
| CabDetail | license_state |
| CabDetail | owner |
| CabDetail | operator |
| CabDetail | VIN |
| Cargo | cargo_id |
| Cargo | hazmat_id |
| Cargo | company |
| Cargo | address |
| Cargo | city |
| Cargo | state |
| Cargo | zip |
| Cargo | phone |
| Cargo | inspection_code |
| Cargo | effective_date |
| Cargo | Contact_number |
| Cargo | container_id |
| Cargo | manifest_id |
| Detection | detection_id |
| Detection | plan_id |
| Detection | mobile_asset_id |
| Detection | poi_id |
| Detection | envelope_id |
| Detection | mobile_asset_lat |
| Detection | mobile_asset_long |
| Deviations | deviation_id |
| Deviations | mobile_asset_id |
| Deviations | route_id |
| Deviations | plan_id |
| Deviations | deviation_type_id |
| DeviationType | deviation_type_id |
| DeviationType | description |
| DeviationType | critcality |
| Enforcement | enforecment_id |
| Enforcement | org_id |
| Enforcement | sector_1_lat |
| Enforcement | sector_1_long |
| Enforcement | sector_2_lat |
| Enforcement | sector_2_long |
| Enforcement | sector_3_lat |
| Enforcement | sector_3_long |
| Enforcement | Sector_4_lat |
| Enforcement | sector_4_long |
| Envelope | envelope_id |
| Envelope | org_id |
| Envelope | poi_id |
| Envelope | sector_1_lat |
| Envelope | sector_1_long |
| Envelope | sector_2_lat |
| Envelope | sector_2_long |
| Envelope | sector_3_lat |
| Envelope | sector_3_long |
| Envelope | sector_4_lat |
| Envelope | sector_4_long |
| Envelope | altitude |
| Envelope | criticality |
| Envelope | status |
| HAZMAT | hazmat_id |
| HAZMAT | symbol_id |
| HAZMAT | proper_shipping_name |
| HAZMAT | hazard_class |
| HAZMAT | un_number |
| HAZMAT | packing_group |
| HAZMAT | label |
| HAZMAT | special_provisions |
| HAZMAT | exception_text |
| HAZMAT | nonbulk |
| HAZMAT | passenger_air |
| HAZMAT | cargo_air |
| HAZMAT | vessel |
| HAZMAT | vesselsp |
| HAZMAT | sort_order |
| Metrics | poi_id |
| Metrics | envelope_id |
| Metrics | criticality |
| MobileAsset | mobile_asset_id |
| MobileAsset | operator_id |
| MobileAsset | cargo_id |
| MobileAsset | Origin_lat |
| MobileAsset | origin_long |
| MobileAsset | destination_lat |
| MobileAsset | destination_long |
| MobileAsset | departure |
| MobileAsset | arrival |
| MobileAsset | mode_type |
| MobileAsset | vehicle_id |
| NoteThread | thread_id |
| NoteThread | enforecment_id |
| NoteThread | notification_id |
| Notification | notification_id |
| Notification | enforecment_id |
| Notification | detection_id |
| Notification | alert_id |
| Notification | date |
| Notification | response |
| Organization | org_id |
| Organization | name |
| Organization | address_1 |
| Organization | address_2 |
| Organization | state |
| Organization | zip |
| Organization | phone |
| Organization | email |
| Organization | POC |
| POI | poi_id |
| POI | name |
| POI | lat |
| POI | long |
| RailDetail | rail_id |
| RailDetail | engine_id |
| RailDetail | boxcar_id |
| RailEngineDetail | engine_id |
| RailEngineDetail | type |
| RailEngineDetail | license_number |
| RailEngineDetail | DOT_registration |
| RailEngineDetail | owner |
| RailEngineDetail | operator |
| RailEngineDetail | color |
| RailEngineDetail | markings |
| RailEngineDetail | capacity |
| Route | route_id |
| Route | source_id |
| Route | mobile_asset_id |
| Route | plan_id |
| Route | lat |
| Route | long |
| Route | expected |
| Route | actual |
| Route | type |
| Route | cargo |
| Route | driver |
| Route | altitude |
| Route | vehicle_id |
| SecGroup | sec_id |
| SecGroup | type |
| SecGroup | status |
| SecGroup | group_id |
| SignageRoster | Roster_id |
| SignageRoster | signage_id |
| SignageRoster | driver_id |
| SignageRoster | add_date |
| SignageRoster | status |
| Source | source_id |
| Source | user_id |
| Source | name |
| Source | type |
| Symbol | symbol_id |
| Symbol | company |
| Symbol | address |
| Symbol | facility address |
| Symbol | city |
| Symbol | state |
| Symbol | zip |
| Symbol | class_tester |
| Symbol | specifications |
| Symbol | regulation_number |
| Symbol | drum_manufacturer |
| Symbol | cylinder_manufacturer |
| Symbol | pail_manufacturer |
| Symbol | other_container |
| Symbol | approval_date |
| TrailerDetail | trailer_id |
| TrailerDetail | type |
| TrailerDetail | color |
| TrailerDetail | markings |
| TrailerDetail | DOT_number |
| TrailerDetail | license_number |
| TrailerDetail | license_state |
| TrailerDetail | owner |
| TrailerDetail | operator |
| TrailerDetail | capacity |
| TruckDetail | truck_id |
| TruckDetail | cab_id |
| TruckDetail | trailer_id |
| Users | user_id |
| Users | org_id |
| Users | sec_id |
| Users | first_name |
| Users | last_name |
| Users | address_1 |
| Users | address_2 |
| Users | state |
| Users | phone |
| Users | fax |
| Users | email |
| Validation | validation_id |
| Validation | user_id |
| Validation | notification_id |
| Validation | enforecment_id |
| Validation | explanation |
| VesselDetail | vessel_id |
| VesselDetail | type |
| VesselDetail | country_registration |
| VesselDetail | license_number |
| VesselDetail | color |
| VesselDetail | markings |
| VesselDetail | capacity |
| VesselDetail | name |

Modal Implementations

A description of an implementation of the system of a preferred embodiment of the present invention has been provided for large, over-the-road tractor/trailers (“TTIDN”). However, the system works as well and, in every case, more easily when used for managing HazMat carried by other mobile platforms: buses, railroad rolling stock, ships and barges, or aircraft. With the implementation of the system of a preferred embodiment of the present invention for other transportation modes it may be desirable to augment the basic functionality described above with certain other features and capabilities. Moreover, with the development of newer technologies and communications infrastructures, it will be possible to provide additional and upgraded functionality for the system of a preferred embodiment of the present invention used even on tractor/trailers. Examples of other modalities, as shown in FIG. 2, that may utilize the above described system or other embodiments of the above-described system include:

TTIDN: for trucks, (as described earlier)

ATIDN: for aircraft,

RTIDN: for rail rolling stock,

VTIDN: for ships and barges,

BTIDN: for buses.

These embodiments are described above or below. It is to be expressly understood that other embodiments for other modalities or variations on these modalities are also covered under the claimed inventions.

ATIDN: Aircraft Threat Identification Detection and Notification System.

Of the several transportation modalities that the system of a preferred embodiment of the present invention addresses, commercial aircraft and particularly passenger and cargo aircraft are the most closely monitored of the intermodal vehicles. No other form of cargo transport operates under what is essentially full-time, real-time radar surveillance. Such surveillance is, however, maintained for the vehicle itself and not for its cargo. Commercial aircraft take off and land at very specific and carefully recorded times and places, but the oversight is conducted on and the records maintained for the aircraft itself rather than for the potentially dangerous and hazardous cargo that may be onboard. There is, thus, need for an Aircraft Threat Identification Detection and Notification system. ATIDN operates by associating any piece of HazMat cargo with the aircraft in which it is being shipped. The HazMat cargo, therefore, becomes (for purposes of the system data structure) an attribute of the aircraft itself, and the cargo is tracked and monitored by tracking and monitoring the aircraft. Because the positional data for all commercial aircraft is known to air traffic control from radar transponders while the aircraft are flying and, while they are on the ground, by the location of the airports at which they have landed, the location of all HazMat may be tracked once it is associated with the tail number of an airplane.

In order to effect a useful ATIDN, the system will thus preferably require inputs of data regarding both the HazMat parcel and the vehicle that is carrying it. The system will also require information about the location and status of the aircraft carrying the parcel. Such data and information is available from air traffic operations under FAA control, and, existing interfaces can be used for tracking aircraft location and status in for use in ATIDN. Additional data to be collected will include: operator, capacity, markings, color, owner, aircraft ID, N—Number, MMS, and other data.

The HazMat cargo enters the ATIDN at the point at which it is delivered to the freight forwarder, carrier, package delivery company or other consignee. All the system implementations have a definitive boundary that consists of that point in the travel of the HazMat cargo at which it is registered as HazMat—into a shipping/delivery system and, on the other end of the trip, out of that system.

The system depends, therefore, on the existence of a reasonably reliable HazMat registration system. Such reliability implies, in turn, a mandatory registration such that both the party initiating the shipment of HazMat and the party carrying the shipment conduct business under a legal obligation to register HazMat into the system, collect necessary information about the shipment, and transmit this information into (in this case) the ATIDN.

Such registration systems are a part of the business process of the large package delivery. These systems require the shipper to mark and describe the HazMat per Part 49 of the US Code. In the case of carriers with such well-established internal procedures ATIDN requires only that this internal information be transmitted to the ATIDN knowledge management system.

Most cargo firms such as FedEx and UPS have very highly-evolved tracking capabilities: they are able to determine where in their own systems a package is located and when it is scheduled to arrive. For HazMat packages in air transit, the combination of aircraft positional and status information from FAA sources and HazMat descriptive data from the shipper and package carrier will be the principal inputs to ATIDN and will provide the basis for a sound and useful system. It must be noted that HazMat materials are carried on commercial aircraft chartered by firms that have less sophisticated and in some cases non-existent capabilities for tracking HazMat materials. Companies like FedEx, UPS, and USPS are in the business of on time delivery, their existence and profitability depend on this type of close loop system. These types of companies will be able to quickly interface to ATIDN.

At the point at which the HazMat cargo leaves the aircraft the attribute association between the aircraft and the package is broken; the HazMat container or package is, however, still in the system because it has not passed out of the system boundary (an event which occurs when the package is accepted by the first consignee outside of the system, typically the party designated to be the recipient by the shipper). If the HazMat package is transferred to another aircraft the HazMat package becomes an attribute of that aircraft for the next leg of its journey. If the HazMat package is loaded onto a truck it then becomes an attribute of the truck for the next leg.

RTIDN: Rail Threat Identification System.

The rolling stock associated with rail carriage brings with it its own set of opportunities, limitations and particular characteristics. Railroad cars do not typically carry small HazMat packages or parcels, but rather, frequently carry extremely large quantities of flammable, toxic, or corrosive materials. They may be flat cars carrying loaded truck trailers that might conceivably carry HazMat. Railroad cars regularly enter large cities and large military bases, industrial facilities, petroleum storage areas, etc.

Since railroad cars are restricted to their tracks, they are quite different in range of movement from the other modalities shown in FIG. 3 to which the system of a preferred embodiment of the present invention may be applied. While other vehicles may move relatively freely in two or three dimensions, rail traffic is restricted to one.

This restriction in movement has made it possible to track railroad rolling stock, car by car, as it passes specific points. Presently, TransCore's Amtech subsidiary claims that 95% of all rail cars in the United States are fitted with its RF transponder tags. Such a capability makes it possible to locate at specific interrogation points the position of any particular rail car and to follow the car as trains are decomposed and recomposed. It is thus possible in principle to develop vocational data for individual rail cars including those with HazMat cargos.

The Rail Threat Identification Detection and Notification (RTIDN) shares the requirement with the other implementations of the system of a preferred embodiment of the present invention described here that the HazMat cargo must be registered both into and out of the RTIDN system. In the case of a rail implementation, registration into the system by the shipper and carrier will begin with the loading of the HazMat material (corrosive chemicals, fuel, etc.) onto the rail car. This registration of hazardous materials must be in accordance with the mandates of Part 49 USC. Further, the transmission of this information into the RTIDN system must be obligatory. Registration out of the RTIDN system will occur upon delivery of the cargo to the recipient identified as consignee by the entry registration.

Because, in the case of RTIDN as well as the others, the HazMat cargo becomes an attribute (for purposes of the system) of the vehicle in which it is being carried, some additional data regarding the rail car will be needed as well. These include: owner, color, markings, operator, capacity, boxcar ID, license number, boxcar type.

VTIDN: Vessel-Barge Threat Identification and Notification System.

Ships, though they are freer to move in two dimensions than are trucks, are both slower and (because they travel over a more homogeneous medium than trucks) much more easily tracked by radar and photogrammetry. Water-borne craft can carry enormous cargos. Such cargos may, moreover, be carried in two dimensions over most of the surface of the planet, though they present the most acute threat (to human populations and assets) when they are in harbor or in some inland waterway such as the Saint Lawrence Seaway, the Intercoastal Waterway, or the Great Lakes. The sorts of HazMat threats posed by ships and barges are unique because of their prodigious carrying capacity. Cargos of relatively pedestrian quality, such as ammonia fertilizer or liquefied natural gas (“LNG”) can become threats because of the astonishing quantity in which they can be loaded onto a ship or barge. Similarly, ships and barges carrying very ordinary industrial cargo, such as crude oil and caustic chemicals, can be used as powerful weapons for environmental attack because of the magnitude of the spills which can be produced and the proximity of the vessel to water in which to disperse these contaminants.

Thus, in order to constitute a broadly functional system of a preferred embodiment of the present invention, it is preferred that the present system can be adapted so as to enable a Vessel-Barge Threat Identification Detection and Notification (“VTIDN”) system. As was true in the cases of the other (surface and air) cargo transportation modes, certain special-case modifications will have to be made in order to accommodate the special situations posed by water-borne commercial cargo. For instance, ocean freight (except in the case of completely fungible commodities such as crude oil) almost always involves multimodal shipment in the form of containerized cargo. Such containers have radically reshaped ocean freight handling during the past five decades and are inherently transportable by truck or train. The standardized shipping containers look very much like semi-trailers without wheels and are loaded by crane directly onto trucks or rail flat cars for ground shipment inland to a consignee or to distribution points such as a huge inland port for clearing through Customs and subsequent reshipment.

Another feature of ship-borne transportation that is relatively unique is that the larger portion of an international voyage will take place outside of the jurisdiction of national authorities in international waters. However, the principal concern for counterterrorism purposes is control of the ship while it is proximate to land-based resources: a barge on the Mississippi, a ship in Baltimore Harbor, etc. An oil spill or a huge explosion in the middle of the Atlantic is a bad thing, but not nearly so bad as it would be in the Mississippi River or the Chesapeake Bay. Thus, the need for tracking huge, slow vehicles is limited to the times during which they are close to national shorelines such as the U.S. inland waterway system, a system in which all cargo traffic operates under the jurisdiction of the US Coast Guard.

For all the differences noted above, there are broad similarities between water-borne transportation and the other modalities: there is a pilot, a hull identification number, a registered date and point of departure and a corresponding date and point of arrival, and a typical route associated with every passage between two points, and the installation of positioning systems (GPS having almost completely supplanted LORAN-C and Omega) on-board commercial vessels is essentially universal. Accordingly, VTIDN will require the registration of the HazMat carried on the vessel into and out of the system in a fashion essentially identical with the other modality implementations within the system of a preferred embodiment of the present invention. This will involve collection of these items of data: capacity, markings, color, license number, country of registration, vessel type, vessel ID, name, pilot's name and ID.

The regulation of waterbome HazMat, as well as the transportation of HazMat by other modalities are addressed at Chapter 51 of Title 49 of the US Code. Ships and barges are captured by the definition of Motor Carrier at 49CFR5109. However, certain exceptions to these Regulations specific to ships and barges (due to earlier legislation) are noted at 49CFR5117(d), thus, the regulation of HazMat aboard ships and barges in US Inland Waterways is more complex than is the case with other transportation modalities.

BTIDN: Bus Threat Identification Detection and Notification System

Inter-city buses such as those operated by Greyhound and Trailways are also caught (by reference) by the definition of motor carrier at 49CFR5109 (though Section 14501(c) (2)(A) specifically excludes federal regulation of intrastate motor carrier cargos of a hazardous nature). Inter-city buses do, indeed, carry cargo, and there is therefore a need for a Bus Threat Identification Detection and Notification System (“BTIDN”).

Because the technical and operational nature and the regulatory environment of buses is so similar to that of large trucks, the previous discussion of TTIDN and the extended scenario discussion of TTIDN that follows and constitutes the bulk of this document will serve and apply to the treatment of buses in the BTIDN.

Specific data fields for buses will include: license and state, owner, operator, VIN, markings, DOT number, bus ID, bus type, and color.

Summary

The system of a preferred embodiment of the present invention provides a fundamental architecture that will address all of these implementations; it will apply in those frequent instances when HazMat is shipped multimodally. The system of a preferred embodiment of the present invention is the way to make shipments safe with a minimal sacrifice of the individual freedom to drive a truck full of HazMat wherever and whenever the notion strikes. The system requires only that the shipping company register a route and a set of identifying information, input any changes in this route or information, and monitor deviations to the plan. The service done for the common good by requiring such compliance far outweighs any burden of such compliance.

The system of a preferred embodiment of the present invention is without parallel or precedent in the world. Other systems for tracking trucks and trailers are not suited for a HazMat security application; historically, they have been used for route optimization and driver communication. The system of a preferred embodiment of the present invention is only incidentally a tracking system. Principally it is a knowledge management system optimized for maintaining the security of HazMat shipments by combining tracking with rules-based automated decision-making and automated threat communication. The system of a preferred embodiment of the present invention improves reliability with the principal of redundancy. Redundancy has been incorporated at every point at which it has been possible to provide an alternative or standby basis for functionality.

With the implementation of the system of a preferred embodiment of the present invention for other transportation modalities, it may be desirable to augment the basic functionality described above with certain other features and capabilities. Moreover, with the development of newer technologies and communications infrastructures it will be possible to provide additional and upgraded functionality for the system even on tractor/trailers.

Other embodiments of the present invention include the use of broadband communications and interactive capability.

Broadband Communications.

The existing dispensation of wireless infrastructures is dominated by digital and analog cellular telephone. Designed initially for voice transmission, these infrastructures can be made to play a data transmission role, though, depending on the service locally, typical transmission rates (net of overhead) are in the range of 9.6 to 14.4 kbps. This is adequate for a duplex voice channel and more than adequate for the passing of relatively slow data such as that currently produced by the TTIDN mobile unit. Wireless communications infrastructures other than those associated with cellular phone service range in bandwidth from large-footprint services which support very low data rates (e. g., the OrbComm service which supports OmniTracs, or Inmarsat voice-grade services) to somewhat faster (and very expensive) services such as Motorola's ARDIS network and RAM Mobile Data, to localized high speed services such as the Ricochet system deployed in a few major cities by Metricom (currently in Chapter 11 bankruptcy) which will support data transmission rates up to 128 kbps.

The advent of third generation (“3G”) cellular bids fair to radically increase the availability of broadband (up to about 56 kbps) wireless digital service initially in the urban areas and extending, over time, out into the suburbs and more rural regions. Such service will never extend over big water, so it will never reach ships far at sea, but it will be available from mobile platforms in and near our major cities and handle ships near the coast, in harbor and in such constrained routes as the Intercoastal Waterway.

Internet connectivity and interface is specifically contemplated for 3G cellular phones (at least, in their fully-enabled expressions), and the existence of 3G infrastructure will afford a duplex broadband communications channel to and from the system mobile unit. The data rates that will be available will support rich content up to and including video. Thus, for example, a live, quasi-real-time video picture of events transpiring on a truck or train could be brought from or delivered to a mobile platform. This is probably irrelevant in the case of trucks because there will never be many passengers on a truck and the passengers and their affiliations are important in counterterrorism decision-making, but a train or ship represents a rather different situation, and video would be a good support capability to have aboard. Broadband wireless connectivity will also permit the use of certain biometric sensing technologies such as automated facial recognition or voice recognition.

Interactive Capability.

The capacity to operate devices aboard the mobile platform independently of actions of the driver or other local human presence is of potential use in operational scenarios of the system of a preferred embodiment of the present invention. Indeed, this capability lies principally in the communications infrastructure linking the mobile unit and the control/monitoring station, and all of the existing infrastructures currently permit some level of duplex operation or interaction. Such interaction might take a variety of forms, but it is easy to envision two: the transmission of voice or data to persons aboard the mobile platform, and/or the ability to control devices aboard the mobile platform. The cellular telephone system in its various configurations AMPS/CDPD or digital will permit bi-directional voice or data to and from the mobile platform. The OrbComm system will permit bi-directional data (but not voice).

Uses of bidirectional voice in potential vehicle compromise situations are obvious to verify operator ID, to permit negotiation with parties who have commandeered the vehicle, or for communication with trusted parties while any of a variety of unpredicted situations is resolved.

Applications of bi-directional data communications of even very low bandwidth data may also be useful. Essentially, any device, which can be controlled by a manual switch can also be controlled by a relay or transistor switch. This means that any electrical device can be remotely controlled and that any mechanical device which can itself be controlled by an electrical device can be remotely controlled. It is, for instance, possible to stop a vehicle's engine remotely. In gasoline engines this is generally done by placing an electrical switch in the wiring to the primary coil of the distributor. Diesel engines, because of their very different ignition, will require remote control of a fuel-line interrupt valve. Doors may be locked, and windows may be closed. Tracking beacons can be commanded to come on, and other interdictory devices may be deployed.

E) The Passenger Threat Identification Detection and Notification System (PTIDN©)

The Passenger Threat Identification, Detection and Notification system (PTIDN©) is a knowledge-management system tailored to the requirements of commercial airport counterterror security. This system operates by acquiring data from existing airline ticket reservation systems such as the well-known SABRE system, processing and archiving this data, and matching the passenger data thus assembled against forensic databases maintained by national law enforcement and civil security agencies for purposes of maintaining civil order and internal homeland security. These databases include those maintained by the National Crime Information Center (“NCIC”) and the Immigration and Naturalization Services (“INS”).

(1) The Nature of the Problem.

On the basis of the year 2000 US domestic passenger air travel data, it is estimated that there are approximately 100,000,000 airline ticket purchase events in the US annually. Since the events of Sep. 11, 2001, both the Federal government and the citizenry have a sharply heightened concern for airline security in general and for threats from international terrorists in particular. Those individuals and organizations responsible for assuring safe travel in the US air transportation industry are confronted with the daunting task of separating out that very tiny portion of the traveling public which constitutes a danger to the rest of the traveling public. The problem, then, is a problem of dilution: the saturation of the traveling public with active terrorists is estimated to be on the order of one in ten million . . . one traveling active terrorist for every ten million passages on domestic flights.

(2) Existing Systems.

A number of systems have been either developed or proposed for development which would substantially increase the probability of filtering out the one-in-ten-million passengers who is a terrorist. Examples of these are the existing Computer Assisted Passenger Pre-Screening System (“CAPPS”) being operated by the US Government. CAPPS was initiated to screen passenger baggage but has, since September 11, been extended to perform a passenger screening function as well. Other examples of airline passenger screening functionality are represented by the various counterterrorist systems based on the automation of database search capabilities such as the multi-media database “Checkpoint” system developed by HDS, Inc. All of these systems take a variety of inputs from individual passengers (photos, passport scans, fingerprints, information from various text fields such as flight number, ticket number, etc.) And search established databases for matching information. Such intensive techniques can work very well to support the interdiction or deterrence of terrorists on commercial flights. They all, however, suffer from the problem of dilution: none of them can support usage at the levels of 200,000,000-passenger check-ins per year, which characterize the US industry.

They all create bottlenecks if applied to the entire flying public—or even to a substantial portion thereof. In order to overcome this problem of bottlenecking the capacity of these systems would have to be vastly expanded—an effort which would be massively costly in both dollars and in time lost, if it is physically feasible at all—or to somehow reduce the number of passengers which these intensive screening systems have to process.

(3) The PTIDN Solution

The purpose of the PTIDN is to achieve universal passenger pre-screening to augment commercial air transport security of the flying public and to assist law enforcement authorities in determining who is or who may be a threat.

PTIDN© achieves this refinement of functionality through a “filtering and funneling” approach as illustrated in FIG. 1—wherein already available data (that is, data which exists for passengers by virtue of their having reserved a seat by purchasing a ticket) is used as a “Coarse Filter” to pre-screen airline passengers such that only a relatively few passengers are selected for further screening by CAPPS (“Medium Filter”) or some other investigatory modality, which may be no more formalized than an ad hoc interview with law enforcement personnel (“Fine Filter”).

Key to the efficacy of PTIDN© is the extraction and use of available reservation data currently available from every one of the existing airline reservation systems. PTIDN© adds no additional delay or other inconvenience to the air travel experience except in those relatively rare instances in which a passenger is directed to a channel for more careful screening. Often these diversions will occur much earlier than the actual day of the flight on which the passenger is to be emplaned. FIG. 6 provides a diagram of PTIDN© operation.

(4) Interface with Passenger Reservation Systems.

Currently, all US travel reservations for airline seats go through reservations systems such as Sabre. The Sabre system is well known in the commercial air travel industry. Though initiated by American Airlines, it has now come to be extended to and utilized by the entire industry. It is currently used by 61 airlines worldwide and is used for ticketing more than 300 million passengers every year. Existing reservations systems such as Sabre can be readily modified to create and transmit a transaction based on seat reservation data, and this data can be used for pre-screening.

When a traveler purchases an airline ticket from an agent. the agent starts entering data from the traveler into the Sabre system. Name, phone number and credit card information are taken initially. Upon booking, flight numbers, points and times of departure and arrival are recorded.

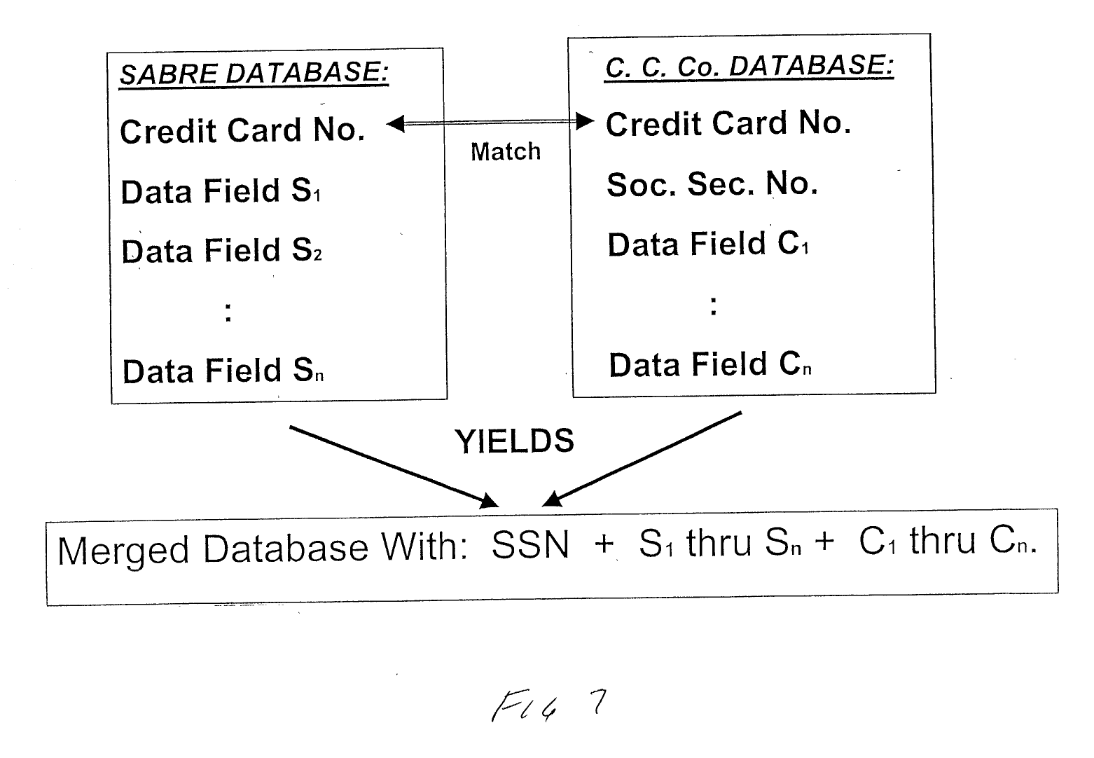

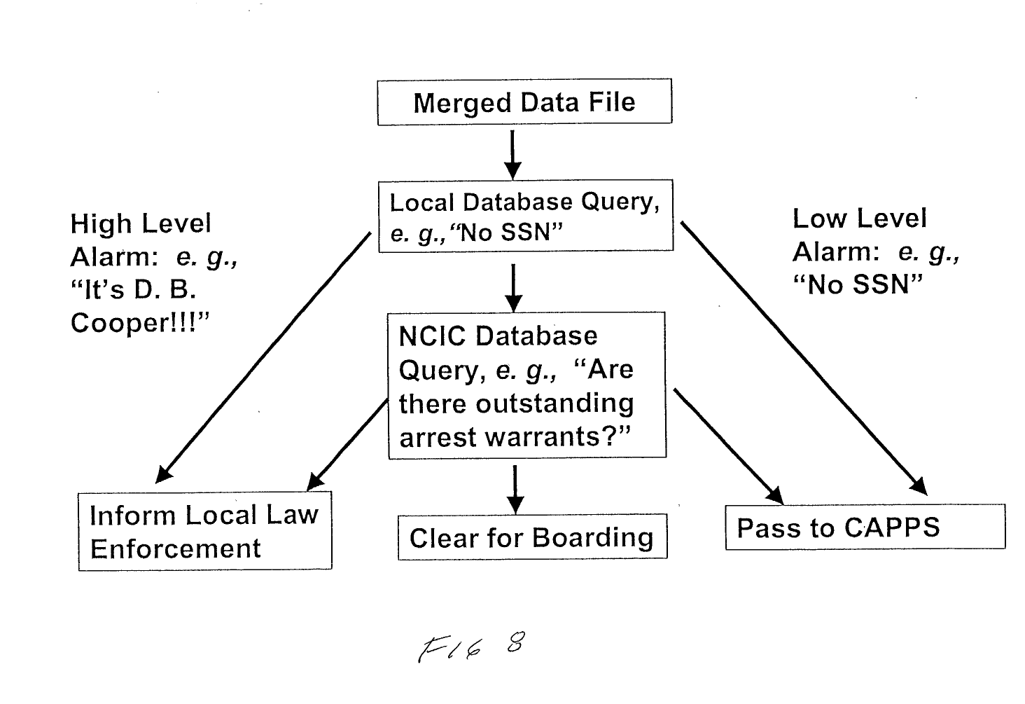

This is very minimal data. It is not all of the data that one would record if one had designed Sabre specifically for the purpose of maintaining security aboard commercial air flights. It does not, in particular, solicit Social Security Number, and SSN is the closest instrument currently available to a national identification number for US citizens. However, credit card number can be used as an identifier against other existing relational databases which contain SSN, and SSN can thereby be derived for those parties purchasing by individual credit card number. This matching and derivation is illustrated in FIG. 7. A huge proportion of tickets are paid for by credit card. For those parties paying by cash, the SSN would not be available; however, recent terrorist incidents have involved cash purchases of tickets, so it is not unreasonable to have all cash purchases caught by the PTIDN© filter and funneled into CAPPS or some similar screening system. In the instance of cash ticket purchase additional validation information could be requested; this might include state issued driver's license numbers or passport numbers to assist with SSN checks. It should be noted that PTIDN© would confirm that the SSN is a valid SSN issued by the Commerce Department and not a number “re-cycled” because of death or actually assigned to someone else (as a result of stolen documents). Non-citizens will not have a SSN—even if they do have a credit card—so they, too, could be directed into a more intensive screening process.

(5) PTIDN© Processing and Output.

Input into the PTIDN system is co-extensive with the output—for all US-originated flights—of airline seat reservation systems such as the Sabre Passenger Reservation System. This system is ajoint asset of all of the larger airlines, and their co-operation in providing this information is presumed.

Processing within the PTIDN© system is organized into two broad categories:

The concatenation or “chaining” of databases,

The application of a set of decision-support rules to the data generated by PTIDN©.

A great deal of data exists in databases accessible on a free or reimbursed basis through the Internet. The key to utilizing these databases is the association of the passenger with some common (or associatable) identifier. This is, optimally, SSN, and the PTIDN© system operation relies upon the collection (though Sabre) of credit card number and the association of credit card number with SSN in credit card clearing databases described in FIG. 7. With SSN, a number of other databases may be interrogated—in Internet time—for data which would be relevant for the application of decision-support rules. These databases include the various criminal record databases maintained by the National Crime Information Center (“NCIC”), credit card activity databases (e.g., to determine whether a credit card had been used elsewhere to other purchase tickets or provocative merchandise for target parties), lists of stolen credit cards, Interpol, Passport files, INS files, US Customs files and so forth.

The data obtained from the various databases is then compared with a predetermined standard to determine whether the passenger poses a threat to the carrier. Typical rules would be applied in a typical dendritic (“tree diagram”) pattern, e.g.:

IF “No SSN” THEN “Default to next level of screening.”

IF “SSN” THEN “Is SSN a valid SSN and are the names associated with SSN and reservation the same?”

IF “SSN” THEN “Are names associated with SSN and credit card the same?”

IF “Yes” THEN “Are the names associated with credit card and passenger the same?”

IF “Yes” THEN “Is there a watch-list entry or outstanding warrant?”

IF “No” THEN “Does passenger name appear on any other government watch-list?”

IF “No” THEN “Mark as ‘Cleared for Boarding.’”

The PTIDN© system is user-configurable to reflect the concerns—the possibly changing concerns—of the user.

The Department of Transportation (DOT), operating in concert with probably other appropriate Federal agencies is the most appropriate sponsor to host and house such an air passenger screening capability and to serve as the focal point for coordinating with these other parties. PTIDN© is designed to be a distributed system that can interact with any other system in a secure and efficient manner. Data transmitted and information processed by PTIDN© can be aggregated to a national DOT Command/Control center for monitoring and assessment. All data transmission would preferably be encrypted.

When data packets are created by the airline reservation system they are preferably transmitted to PTIDN© and captured by a server located at a regional site. These data packets are to be matched against the various Federal agency databases and watch-lists and the results provided to the DOT, and by DOT to appropriate law enforcement agencies and the airlines. The data archived in the PTIDN© is to be used for ongoing trend and pattern processing for subsequent analysis of travel patterns including repetitive travel between city pairs and other activities of concern. Such activities might include: flying on the same flights as known suspects, purchasing weapons, applying for a HazMat vehicle operator's license or purchasing explosives.

(6) Interface with More Intensive Screening and Scrutiny Processes.

As described hereinabove, the comprehensive counterterrorist screening function will be a three-tier system.

PTIDN© association rules (including SSN validation and use of name-manipulation software such as “Citizenry Software”),

CAPPS, and if required

Individual questioning and background-checking by civil authorities.

CAPPS is itself a relatively automated system, and it is projected that the 10% of the passengers filtered by PTIDN© and funneled to CAPPS will be subjected to no more than a few minutes of delay. If one presumes that CAPPS will clear 90% of those passengers sent to it, then only 1% of total passenger load will be subject to intensive screening, involving photographs, interviews, delays long enough to miss a flight, etc. If one were to presume that typical annual US passenger ticket purchases remains at a level of approximately 100 million per year, this would mean that about 10,000 passengers per year would be subject to intensive screening and that perhaps ten of these persons would prove to be terrorists. These, are workable numbers. The great virtue of PTIDN© is that it reduces an unworkable number to a workable number.

This critical decision-support functionality of the system is illustrated in FIG. 8.

(7) PTIDN© in Overview.

PTIDN© offers a simple but effective mechanism to uniformly integrate reservation data from all airlines, to match observed data against forensic watch-lists, maintain Federal control over the terrorist monitoring activity . . . and accomplish all of this without levying an undue financial burden upon an already-stressed industry. In addition to this, PTIDN© provides the basis for analysis of trend and pattern data and the capacity to exchange data with other terrorist profiling software and systems.

The system of a preferred embodiment of the present invention is a tailorable framework. A part of its appeal is its adaptability to a variety of situations, user requirements, and transportation modalities

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A process of pre-screening passengers prior to their boarding a carrier to determine whether anyone poses a threat to the safety of the carrier, comprising the steps of:
routinely collecting and recording reservation information relating to the individual passengers and the reserved carrier;
inputting said information into a processor and responsively obtaining other information available from various stored databases;
comparing said reservation information and said other information with a predetermined template to determine whether any of the passengers poses a threat to the carrier.

2. A process as set forth in claim 1 and including the step of notifying authorities if a threat is indicated.

3. A process as set forth in claim 1 and including the step of permitting the passenger to board if no threat is indicated.

4. A process as set forth in claim 2 wherein the particular authority level to be notified is dependent on a degree of threat determined.

5. A process as set forth in claim 1 wherein said step of collecting and recording reservation information includes the step of obtaining a social security number applicable to the passenger.

6. A process as set forth in claim 5 wherein said step of obtaining a social security number includes the steps of obtaining a credit card number and responsively entering a database to obtain the social security number.

7. A process as set forth in claim 1 wherein said other information is obtained from federal, state and local authorities.

8. A system for pre-screening carrier passengers having reservations on a carrier to determine whether any poses a threat to the carrier, comprising:
means for collecting and recording information relating to the passengers and the carrier on which reservations are made;
a first processor for receiving said recorded information and responsively generating related information from various shared databases; and
a second processor for comparing said recorded information and said generated information with a predetermined representative template to determine whether a passenger poses a threat.

9. A system as set forth in claim 8 and including means for notifying authorities in the event that a threat is found to be posed.

10. A system as set forth in claim 8 and including means for permitting passengers to board if no threat is found.

11. A system as set forth in claim 8 wherein said means for collecting and recording is adapted to collect and record the passengers respective credit card numbers.

12. A system as set forth in claim 8 wherein said means for collecting and recording is adapted to collect and record the passengers respective social security numbers.

13. A system as set forth in claim 11 wherein said first processor receives said credit card numbers and generates related social security numbers.

14. A system as set forth in claim 8 wherein said first processor includes databases from respective federal, state and local authorities.
